(19) United States
(12) Patent Application Publication
(10) Pub. No.: US 2005/0240573 A1
(43) Pub. Date: Oct. 27, 2005

(54) Process of searching required materiel under a protocol mode

(75) Inventor: Chih-Hung Chien, Taoyuan (TW)

Correspondence Address: WELSH & KATZ, LTD, 120 S RIVERSIDE PLAZA, 22ND FLOOR, CHICAGO, IL, 60606, US

(73) Assignee: MITAC International Corp., Hsinchu (TW)

(21) Appl. No.: 10/832,206

(22) Filed: Apr. 26, 2004

(51) Int. Cl. G06F 17/30

(52) U.S. Cl. 707/3

(57) ABSTRACT

A process of searching materiel and supplies under a protocol mode acquires materiel information via a data interchange platform between buyers and suppliers. According to a materiel attribute description rule, a product complying with the materiel attribute description rules can be found in product databases of suppliers. The process includes sending a request of searching the required materiel to the data interchange platform. The data interchange platform activates a protocol mode according to the request. The product information about the required materiel is obtained according to the materiel attribute description rules after the search has been completed. A reply request is then sent to the data interchange platform. The reply request is linked to a component part database. Then, the product information of the required materiel adds to the component part database.

### BACKGROUND OF THE INVENTION

1. Field of Invention

The present invention relates to a process of searching materiel and supplies, and more particularly to a process of searching a required materiel under a protocol mode via a data interchange platform between companies.

2. Related Art

Reducing the production cost can enable to increase the company profit. For standardization, companies build a materiel attribute database including component part specifications and electric characteristics etc., which constitute the materiel attribute description rules used as bases of setting up series numbers of the materiel. For example, the materiel attribute description rules of a hard disk drive include the capacity, rotation speed, data transmission speed, and average data searching time of the hard disk drive.

A supplier materiel database is further needed for the purchaser. The materiel attribute database and the supplier materiel database form a component part database. Therefore, it is convenient to search both the materiel and the corresponding supplier by using the materiel attribute description rules.

Generally, when a company needs to purchase a materiel, it must find out the materiel complying with the materiel attribute description rules and the corresponding supplier according to the specifications and characteristics of the materiel. However, not all the materiel can be used for production. The obtained materiel may not be put into production because producers do not certify it or it is not the one wanted by buyers. The component part database has limited certified data and thus restricts the purchase. Purchasing persons must implement additional searches in order to obtain all the possibilities of buying low-cost materiel. This additional search is usually done manually, which takes time and is less efficient. For example, the purchasing person must contact the sales department of the supplier, which may fail or take time and is not time effective. Further, the supplier may be too small to offer all the needs. In other cases, the sales person of the supplier might not even provide complete information at once. All the above disadvantages can lead to the possibility of losing the cost reduction.

Therefore, there is a need of a process of searching the materiel and supplies via a data interchange platform between companies, which reduces manual searches and reaches standardization and digitalization. According to the process, the production database of the supplier must have a materiel attribute database so that complete materiel information can be acquired from the supplier, and the buyer thereby can reduce its purchase cost via the data interchange platform.

### SUMMARY OF THE INVENTION

In order to solve the above prior problems, the invention provides a process of searching materiel and supplies under a protocol mode, by using a data interchange platform between companies via Internet. In response to a search by a buyer, a seller (or supplier) provides the buyer with the product information of the required materiel so that the buyer can obtain useful search results for purchasing references.

The process of the invention enables to obtain a substantial number of possibilities of buying low-cost materiel and supplies from any supplier. The process includes sending a request of searching the required materiel to the data interchange platform. The data interchange platform activates a protocol mode according to the request. The product information about the required materiel is obtained according to the materiel attribute description after the search has been completed. A reply request is then sent to the data interchange platform. The reply request links to a component part database. Then, the product information of the required materiel is added to the component part database.

Therefore, as long as both suppliers and buyers build the materiel attribute description rules, the materiel complying with the required attribute description is obtained from the supplier. Not all the materiel may be used for production. The obtained materiel may not be put into production because producers, for example, do not certify it or it is not wanted by buyers. Therefore, all the materiel complying with the required attribute description is added to the component part database.

It will be understood that the foregoing summary encompasses some of the many features of the invention, and does not constitute an exhaustive description of all the aspects of the invention. Therefore, the summary of the invention should not be construed in a way to limit the scope of the invention as described in the claims. To provide a further understanding of the invention, the following detailed description illustrates embodiments and examples of the invention.

### BRIEF DESCRIPTION OF THE DRAWINGS

FIG. 1 is a schematic view of a process of searching a required materiel under a protocol mode via a data interchange platform between companies;

FIG. 2 is a flowchart of a process of searching a required materiel under a protocol mode according to one embodiment of the invention; and

FIG. 3 is a flowchart of a process of searching the required materiel under a protocol mode according to one embodiment of the invention.

### DETAILED DESCRIPTION OF THE INVENTION

The following description of the present invention is intended to be illustrative only and not limiting.

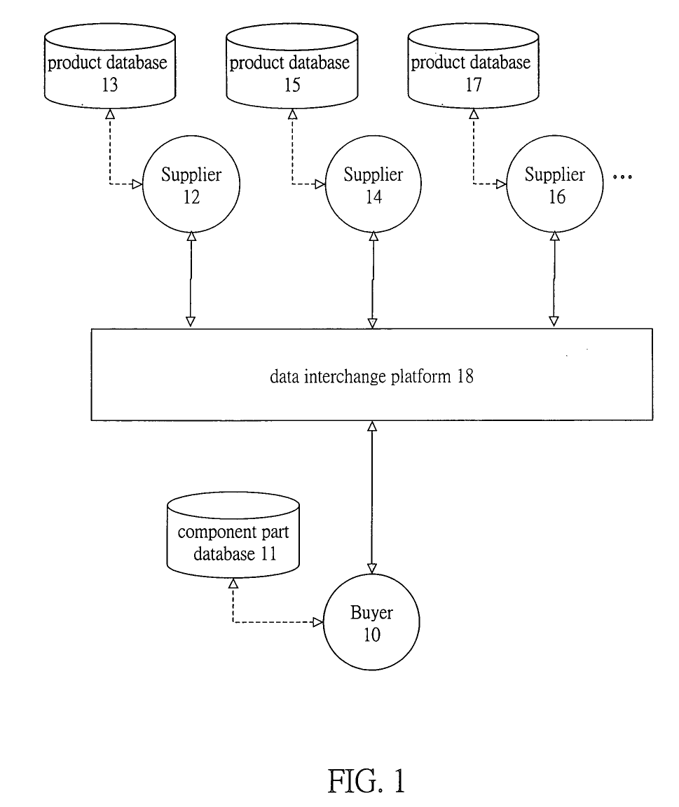

FIG. 1 is a schematic view of a process of searching a required materiel under a protocol mode and via a data interchange platform between companies. The data interchange platform is linked via Internet and is a Web-based system, so that companies can easily and conveniently interchange data. As shown in FIG. 1, a buyer 10 has a component part database 11 where materiel series numbers, component part specifications, electric characteristics and information about suppliers are stored. The buyer 10 searches required materiel in the component part database, or searches required materiel via the data interchange platform 18, to find the one complying with the materiel attribute description rules. The data interchange platform 18 activates a protocol mode to link to, for example, product databases 13, 15, 17 of suppliers 12, 14, 16 as soon as the platform 18 receives a reach request from the buyer 10. When the required materiel, complying with the materiel attribute description rules, is found, the product information and sales information of the materiel add to the component part database 11 of the buyer 10 for purchasing reference.

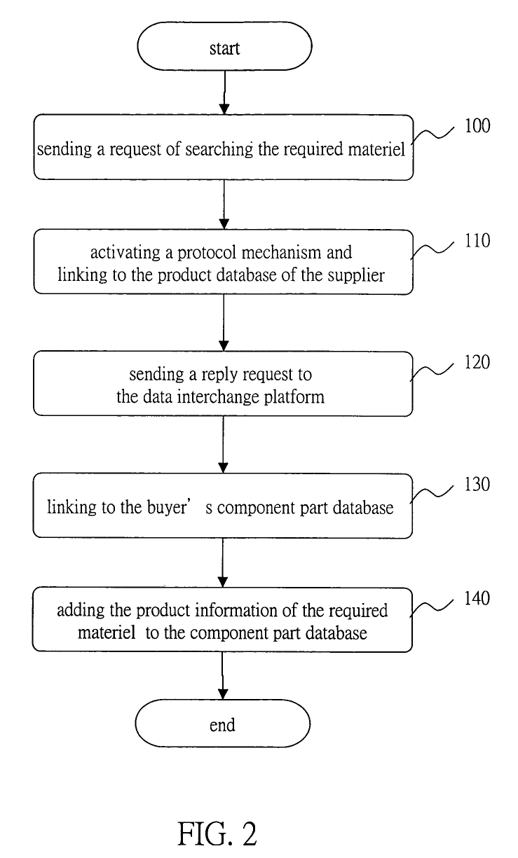

FIG. 2 is a flowchart of a process of searching a required materiel under a protocol mode according to one embodiment of the invention. As shown in FIG. 2, the process includes sending a request of searching the required materiel under diverse forms such as a computer command, an e-mail, a digitally signed document, etc. to the data interchange platform through a computer system (step 100). The data interchange platform activates a protocol mode such as a B2B business data interchange platform according to the request and links to the product database of the supplier (step 110). The product information about the required materiel is obtained according to the materiel attribute description rules such as a component part specification or electric characteristics. A reply request about product information in the form of a computer command, an e-mail, or a digitally signed document is then sent to the data interchange platform (step 120). Then, the data interchange platform activates the protocol mode and links to the buyer's component part database according to the reply request (step 130). The product information of the required materiel is added to the component part database (step 140).

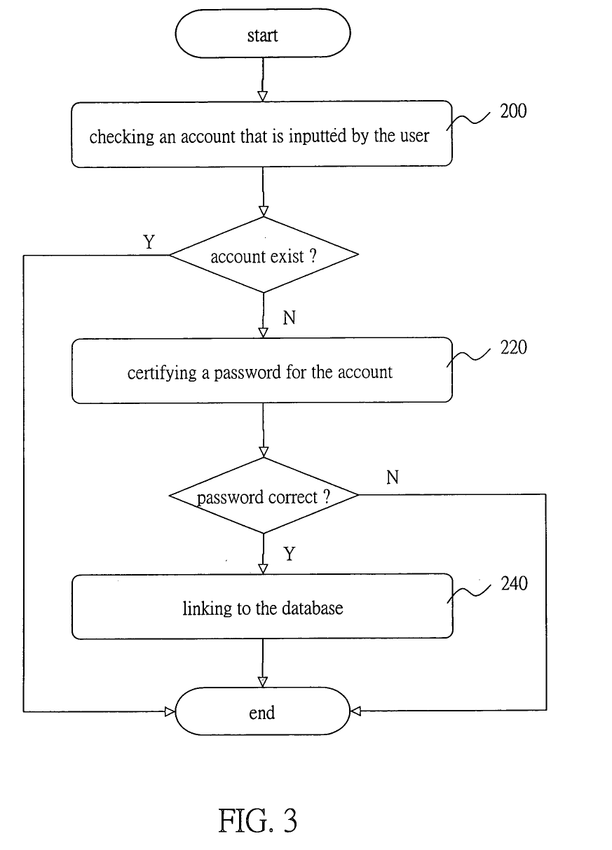

FIG. 3 is a flowchart of a process of searching the required materiel under a protocol mode according to one embodiment of the invention. The information between buyers and sellers are interchanged via the data interchange platform where all accounts of the buyers and sellers are stored. When the protocol mode is activated, it must be certified before linking to the database. As shown in FIG. 3, the protocol mode includes checking whether the account registered by the user exists (step 200). If the account does not exist, then the process ends (step 220). If a password inputted by the user is not correct, then the process ends. Otherwise, it links to the product database of the seller or the component part database of the buyer (step 240).

Those skilled in the art will readily understand that the above description is only illustrative of specific embodiments and examples of the invention, which should not be construed in a limiting way. Therefore, the invention should cover various modifications and variations made to the structure and operations described herein, provided they fall within the scope of the invention as defined in the following appended claims.

1. A process of searching materiel and supplies under a protocol mode, operable to acquire materiel information via a data interchange platform, the process comprising:
sending a search request of a required materiel to the data interchange platform;
receiving the search request, and activating the protocol mode according to the search request;
searching a product database according to a materiel attribute description rule to obtain a product information of the required materiel, and then sending a reply request to the data interchange platform;
receiving the reply request and linking to a component part database according to the reply request; and
adding the product information of the required materiel to the component part database.

2. The process of claim 1, wherein linking of the data interchange platform is achieved via Internet.

3. The process of claim 1, wherein the data interchange platform is a Web-based system.

4. The process of claim 1, wherein the form of each of the search request and the reply request is one selected from the group consisting of an email, a computer a command, and a digitally signed document.

5. The process of claim 1, wherein the protocol mode further comprising:
checking an account that is inputted by the user;
certifying a password for the account; and
linking to the database when the password is correct.

6. The process of claim 1, wherein the component part database includes an attribute database and a supplier database.

7. The process of claim 6, wherein the attribute database includes component part specifications and electric characteristics of the materiel.
